(19) United States
(12) Patent Application Publication
(10) Pub. No.: US 2012/0206775 A1
(43) Pub. Date: Aug. 16, 2012

(54) SYSTEM AND METHOD FOR REAL TIME IMAGE TRANSMISSION AND PREVIEW

(76) Inventors: Chang-Hsien Sung, Taipei (TW); Chien-Shen Chien, Taipei (TW); Chia-Hsiang Wang, Taipei (TW); Pin-Kuan Chou, Taipei (TW)

(21) Appl. No.: 13/025,177

(22) Filed: Feb. 11, 2011

(51) Int. Cl. H04N 1/32

(52) U.S. Cl. 358/442

(57) ABSTRACT

A system for real time image transmission and preview and a method thereof are applied on a scanner having a predetermined format therein, and an electrical device having a display module. The scanner scans a document in lines along a direction repeatedly according to the predetermined format. The scanner can promptly get an image and then wirelessly send the image out after each linearly scanning a part of the document. The electrical device wirelessly receives the predetermined format information and the image sent out by the scanner, and further edits a format of the image to fit in with the predetermined format so as to make the image capable of being displayed by the display module. Wherein the display module promptly displays the image thereon after each linearly scanning a part of the document along the direction and the image get thereby is received by the electrical device.

### BACKGROUND OF THE INVENTION

1. Field of the Invention

The present invention relates to an image transmission and preview system and method thereof, and more particularly to a system and method for real time image transmission and preview.

2. The Related Art

FIG. 7 shows a system for image transmission and display 700 according to a first embodiment of the prior art. The system 700 includes a scanner 701, a computer 702 and a memory card 703. The scanner 701 has a first access device 7010, the computer 702 includes a host 7020 and a displayer 7021, and the host 7020 has a second access device 7022. In use, the user needs to insert the memory card 703 in the first access device 7010. Then, the scanner 701 scans the document. After the scanning is finished, the image got thereby is stored in the memory card 703. Then, the memory card 703 is drawn out from the first access device 7010 and inserted into the second access device 7022. The host 7020 reads the image in the memory card 703 and displays the image on the displayer 7021. However, during the scanner 701 scanning the document, there is not any image stored in the memory card 703. In other words, the system 700 must store the image after the document is completely scanned from stem to stern. As a result, a long time is taken to display the scanned image of the document. Moreover, the system 700 can not preview the image in real time, so whether the image is correct or not can not be determined in time.

FIG. 8 shows a system for image transmission and display 800 according to a second embodiment of the prior art. The system 800 includes a scanner 801, a computer 802 and a cable 803. The computer 802 includes a host 8020 and a displayer 8021. The cable 803 connects the host 8020 with the scanner 801 for transmitting corresponding scanned data from the scanner 801 to the host 8020. Generally speaking, the cable 803 may be a USB cable or a RS-232 cable, and so on. The scanner 801 scans the document to get an image, then, the image is transmitted to the host 8020 through the cable 803. The host 8020 reads the image and then displays the image on the displayer 8021. Even though the system 800 cancels the use of the memory card 703 compared with the system 700, the system 800 still must wait for the completion of the scanning and then make the image displayed on the displayer 8021. Moreover, the distance between the scanner 801 and the computer 802 is limited by the length of the cable 803.

FIG. 9 shows a system for image transmission and display 900 according to a third embodiment of the prior art. The system 900 includes a scanner 901, a computer 902 and a cable network 903. The computer 902 includes a host 9020 and a displayer 9021. The cable network 903 connects the host 9020 with the scanner 901 for transmitting corresponding scanned data from the scanner 901 to the host 9020. Generally speaking, the cable network 903 may be a local area network or an internet, and so on. The scanner 901 scans the document to get an image, and then the image is transmitted to the host 9020 through the cable network 903. The host 9020 reads the image and then displays the image on the displayer 9021. Though the distance between the scanner 901 and the computer 902 is not limited any longer compared with the system 800, the system 900 still must wait for the completion of the scanning and then make the image displayed on the displayer 9021. So, the system 900 still can not display the image in real time.

### SUMMARY OF THE INVENTION

Accordingly, an object of the present invention is to provide a system for real time image transmission and preview. The system for real time image transmission and preview is applied on a scanner and an electrical device. The scanner has a predetermined format therein for scanning a document based on the predetermined format. The scanner further scans the document in lines along a direction repeatedly. The scanner is capable of promptly getting an image and then wirelessly sending the image out after each linearly scanning a part of the document along the direction. The electrical device has a display module therein. The electrical device wirelessly receives the predetermined format information and the image sent out by the scanner, and further edits a format of the image to fit in with the predetermined format so as to make the image capable of being displayed by the display module. The display module of the electrical device promptly displays the image thereon after each linearly scanning a part of the document along the direction and the corresponding image get thereby is received by the electrical device.

Accordingly, another embodiment of the invention is to provide a method for real time image transmission and preview applied to a scanner and an electrical device. The electrical device includes a display module. The method comprises steps as follows:
First, the scanner having a predetermined image format therein and further wirelessly sending corresponding information of the predetermined image format to the electrical device;
Second, the scanner scanning a document in lines along a direction repeatedly to promptly get a corresponding image after each linearly scanning a part of the document along the direction;
Third, the scanner promptly sending the corresponding image to the electrical device after completing each linear scanning of the document;
Fourth, the electrical device promptly receiving the corresponding image from the scanner and further editing a format of the corresponding image to fit in with the predetermined image format information which meets the demand of the display module; and
Fifth, the display module promptly displaying the edited image thereon.

As described above, the system for real time image transmission and preview and the method thereof can be used in the wireless network, and there is the image format adapted to be displayed by the electrical device predetermined in the system. So the scanner immediately sends the partial image to the electrical device after each scanning a part of the document, and the electrical device receives the partial image and instantaneously displays the partial image according to the predetermined image format. Thus the image can be transmitted and previewed by the system in real time.

### BRIEF DESCRIPTION OF THE DRAWINGS

The present invention will be apparent to those skilled in the art by reading the following description thereof, with reference to the attached drawings, in which:

FIG. 1 is a view of a system for real time image transmission and preview of an embodiment in accordance with the present invention;

FIG. 2 is a functional block diagram of the system for real time image transmission and preview shown in FIG. 1;

FIG. 3 is a flow chart showing the relation between a method for real time image transmission and a method for real time image preview;

FIG. 4 is a chart of an information packet of the method for real time image transmission and preview shown in FIG. 3;

FIG. 5 is a flow chart of the method for real time image transmission;

FIG. 6 is a flow chart of the method for real time image preview;

FIG. 7 is a view of a system for transferring and displaying an image according to a first embodiment of the prior art;

FIG. 8 is a view of a system for transferring and displaying an image according to a second embodiment of the prior art; and

FIG. 9 is a view of a system for transferring and displaying an image according to a third embodiment of the prior art.

### DETAILED DESCRIPTION OF THE EMBODIMENT

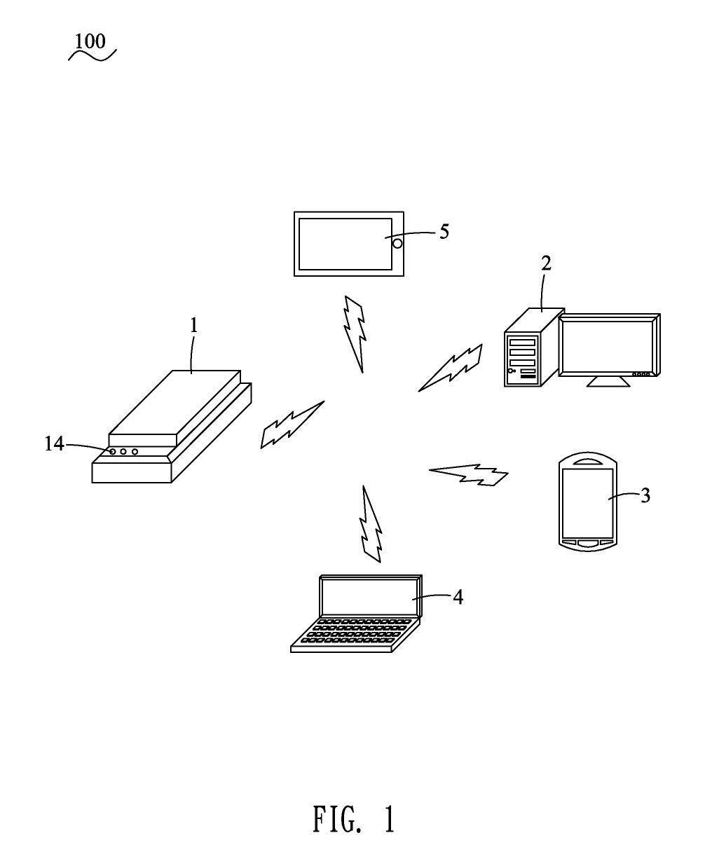

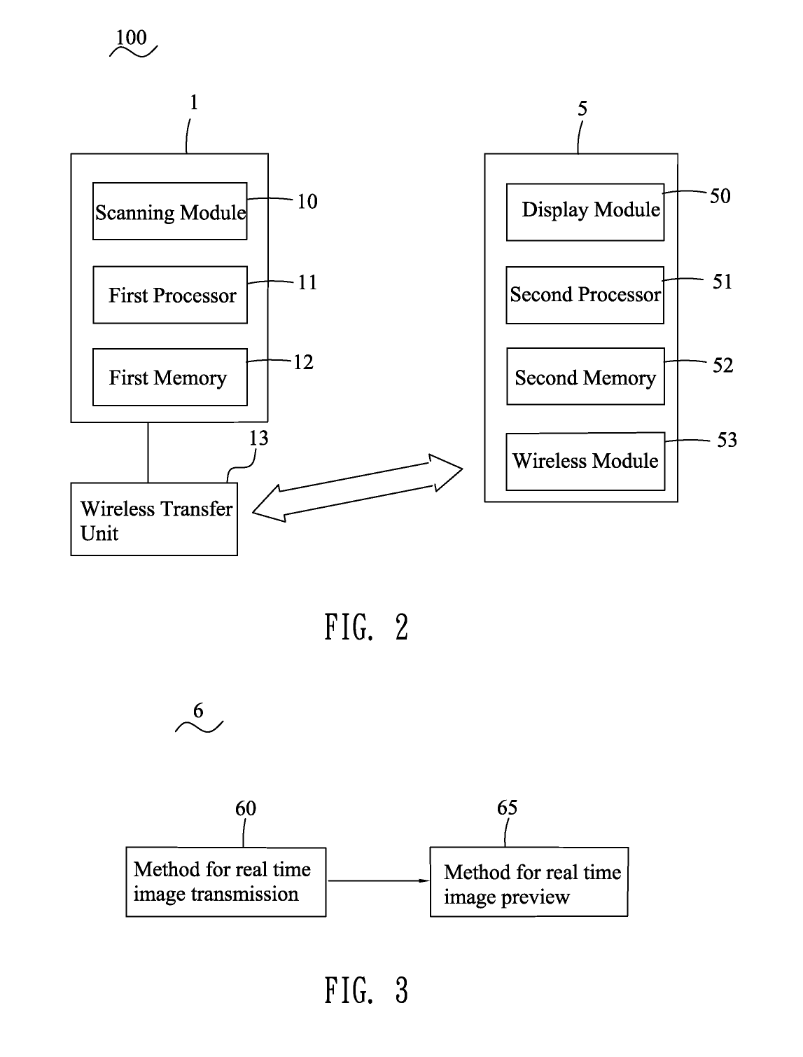

Referring to the drawings in greater detail, and first to FIGS. 1-2, an embodiment of the invention is embodied in a system for real time image transmission and preview 100 applied in a wireless network, such as a WIFI network. The system for real time image transmission and preview 100 has a scanner and a wireless device. The wireless device may be a desktop computer 2, a mobile phone 3, a notebook 4 or an e-book 5, and so on. In this embodiment, the scanner is a handy scanner 1 with a button 14 disposed thereon, the wireless device is the e-book 5, and the handy scanner 1 is able to connect with the e-book 5 through the WIFI network. In detail embodiment, the e-book 5 can be replaced by any electrical device having a wireless connecting function.

With reference to FIGS. 2-3, the handy scanner 1 has a scanning module 10, a first processor 11 and a first memory 12. The handy scanner 1 may be connected with a wireless transfer unit 13 for transferring and receiving information after scanning. The e-book 5 has a display module 50, a second processor 51, a second memory 52 and a wireless module 53. The first processor 11 controls a movement of the scanning module 10 and makes the scanning module 10 scan a document in lines repeatedly. The image got by the scanning module 10 scanning the document is stored in the first memory 12 and then is sent out by the wireless transfer unit 13 under the control of the first processor 11.

The image sent by the wireless transfer unit 13 is received by the wireless module 53 and then is stored in the second memory 52 of the e-book 5. The second processor 51 reads the image from the second memory 52 and then displays the image on the display module 50. In detail embodiment, the wireless transfer unit 13 may be a USB wireless transfer unit which converts a USB signal to the WIFI signal, and the e-book 5 may be a WIFI module.

The scanning module 10 under the control of the first processor 11 moves back and forth repeatedly to scan the document. For example, the scanning module 10 scans the document from top to bottom repeatedly and scans a part of the document each time, until completes the overall scanning of the document after several repeated scanning. After one scanning of the document from top to bottom is finished by the scanning module 10 to generate a partial image, the first processor 11 stores the partial image in the first memory 12. Then the partial image is transmitted to the e-book 5 by the wireless transfer unit 13 connecting with the wireless module 53. The second processor 51 reads the partial image from the handy scanner 1 and makes the partial image stored in the second memory 52. The second processor 51 further edits a format of the partial image to fit in with a predetermined format that can be displayed on the display module 50. As a result, the system for real time image transmission and preview 100 can display the image in real time.

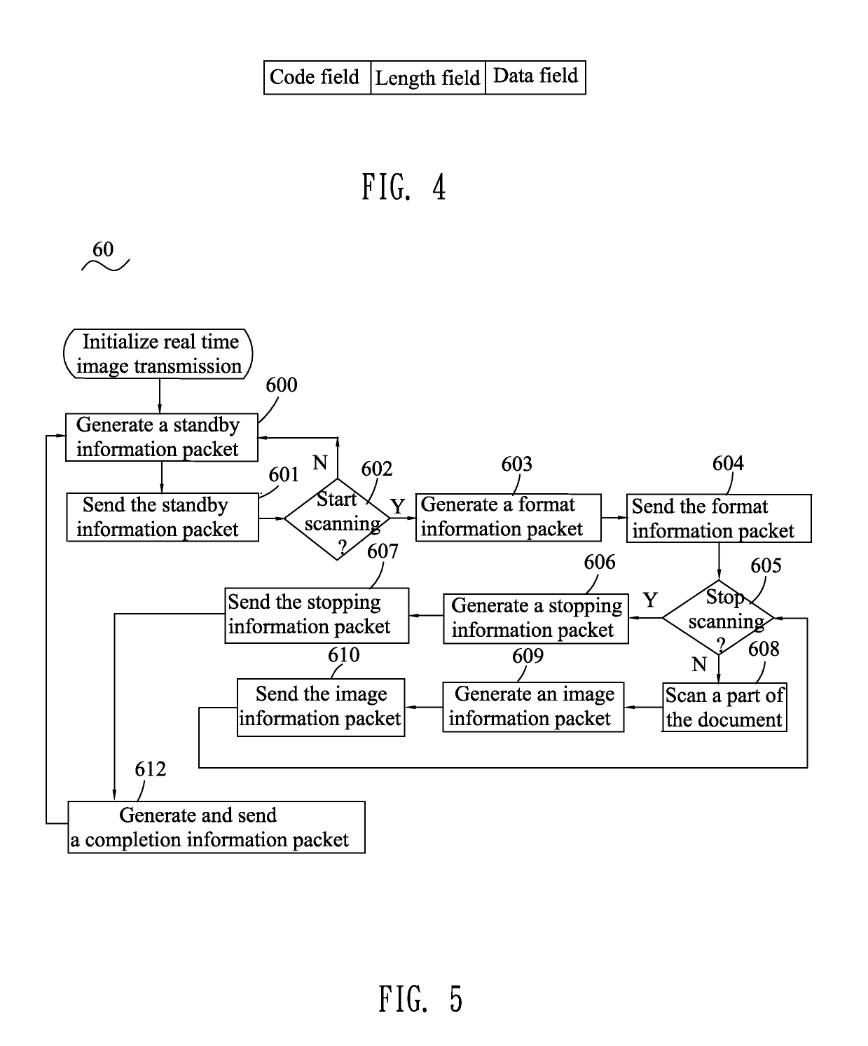

Please refer to FIGS. 3-6 and table 1 attached as below. Programs for real time image transmission and preview of the foregoing system 100 are programmed in the first memory 12 and the second memory 52 respectively. The first processor 11 and the second processor 51 can respectively read the programs in the first memory 12 and the second memory 52 to perform a method for real time image transmission and preview 6.

TABLE 1

| Code | Length | Data | Description |
|---|---|---|---|
| 0X00 | 0 | None | Standby information packet |
| 0X01 | 1 | 0 | First image format information |
| | | | packet |
| 0X01 | 1 | 1 | Second image format information |
| | | | packet |
| 0X01 | 1 | 2 | Third image format information |
| | | | packet |
| 0X01 | 1 | 3 | Fourth image format information |
| | | | packet |
| 0X02 | Length of | Data of | Partial image information packet |
| | the partial | the partial | |
| | image | image | |
| 0X40 | 0 | None | Stopping information packet |
| 0XFF | Length | Data | Completion information packet |
| | of header | of header | |

The method for real time image transmission and preview 6 comprises a method for real time image transmission 60 applied to the handy scanner 1 and a method for real time image preview 65 applied to the e-book 5. Please refer to FIG. 5, the method for real time image transmission 60 includes steps as follows:

Step 600, while the handy scanner 1 is powered on, the first processor 11 reads the program in the first memory 12 to control the operation of the handy scanner 1 and start the real time image transmission of the system 100. When the handy scanner 1 is in a standby mode, the first processor 11 generates a standby information packet.

Step 601, the standby information packet is sent to the wireless transfer unit 13 by the first processor 11, and then is sent out by the wireless transfer unit 13 in the form of WIFI signals.

Step 602, the first processor 11 determines whether the scanning module 10 has began to scan the document or not. If not, the handy scanner 1 maintains the standby mode.

Step 603, when the scanning module 10 has began to scan the document, the first processor 11 generates a format information packet. The format information packet has the code field thereof written in with 0X01, the length field thereof written in with 1, and the data field thereof written in with corresponding data based on different scanning formats of the scanning module 10. In this embodiment, the handy scanner 1 may have four kinds of different scanning formats which are color high-resolution scanning, color low-resolution scanning, gray high-resolution scanning and gray low-resolution scanning, respectively. The data field of the format information packet is written with 0, 1, 2 or 3 according to the different scanning formats described above respectively, which provides a basis for distinguishing the scanning format in which the document will be scanned by the handy scanner 1. The image from scanning the document may be compressed in JPEG format. The image may have a size of 10 inches in length and 5 inches in width. In detail embodiment, the compression format and size of the image may be achieved by other modes.

Step 604, the format information packet is transmitted to the wireless transfer unit 13 by the first processor 11, and then is sent out by the wireless transfer unit 13.

Step 605, the first processor 11 determines the scanning progress of the scanning module 10 scanning the document.

Step 606, when the scanning progress is broken off, the first processor 11 generates a stopping information packet which has the code field thereof written in with 0X40, the length field thereof written in with 0 and the data field thereof be none. The stopping information packet indicates that the handy scanner 1 has stopped scanning the document. In detail embodiment, the scanning progress can be manually broken off by means of pressing the button 14 of the handy scanner 1, or automatically broken off on account of any accidental conditions detected by the first processor 11.

Step 607, the stopping information packet is transmitted to the wireless transfer unit 13 by the first processor 11, and then is sent out by the wireless transfer unit 13.

Step 612, when the scanning of the document is completed in full, the first processor 11 generates a completion information packet which has the code field thereof written in with 0XFF, the length field thereof written in with the size of the header of the predetermined image format, and the data field thereof written in with corresponding data of the header of the predetermined image format. For example, if the size of the header of the predetermined image format is 5 bits, the length field of the completion information packet has a value 5 therein. At this time, the document has been scanned from stem to stern by the handy scanner 1, and the complete image get thereby has been transmitted to the wireless device, such as the e-book 5. Then, the step 600 may need to be re-executed.

Step 608, in the step 605, if the scanning progress is normal, the scanning module 10 moves in lines repeatedly to scan the document part by part.

Step 609, after the scanning module 10 scans the document to generate at least one partial image, the first processor 11 figures out the size of the partial image and then generates a partial image information packet which has the code field thereof written in with 0X02, the length field thereof written in according to the size of the partial image, and the data field thereof written in with corresponding data of the partial image. For example, if the size of the partial image is 256 bits, the length field of the partial image information packet has a value 256 therein.

Step 610, the first processor 11 transmits the partial image information packet to the wireless transfer unit 13, and then the partial image information packet is sent out by the wireless transfer unit 13. Then the foregoing system 100 re-executes the step 605.

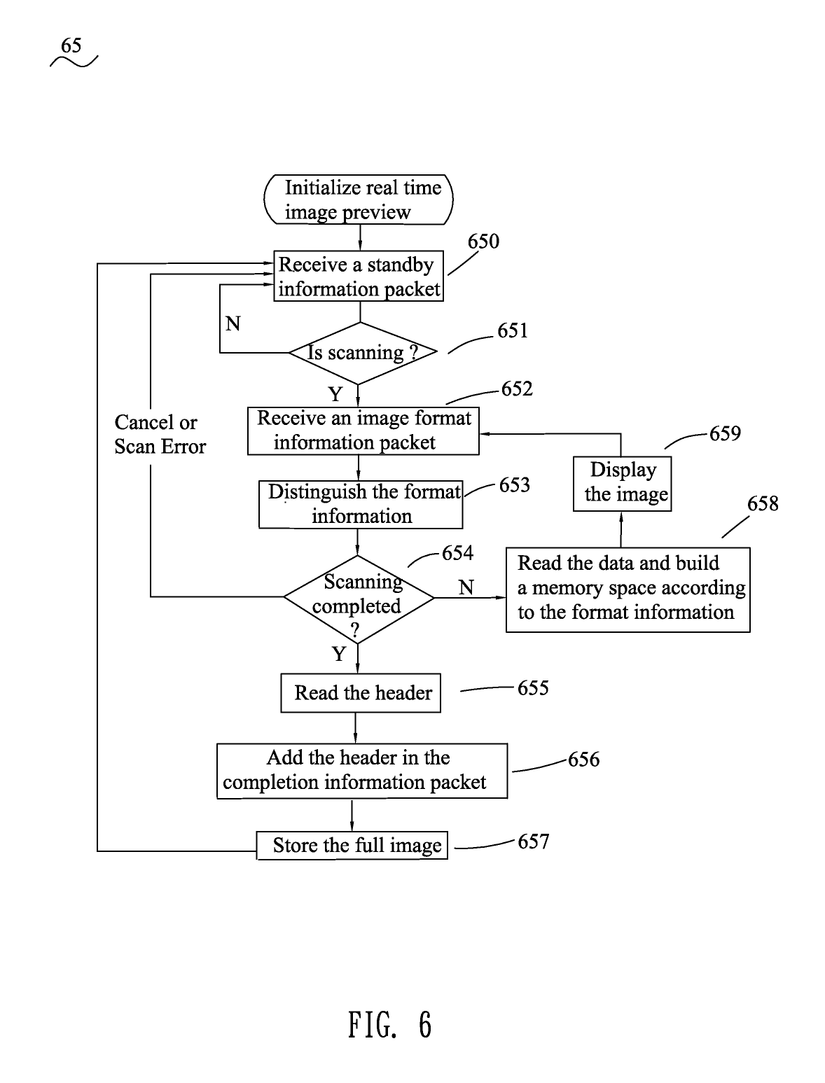

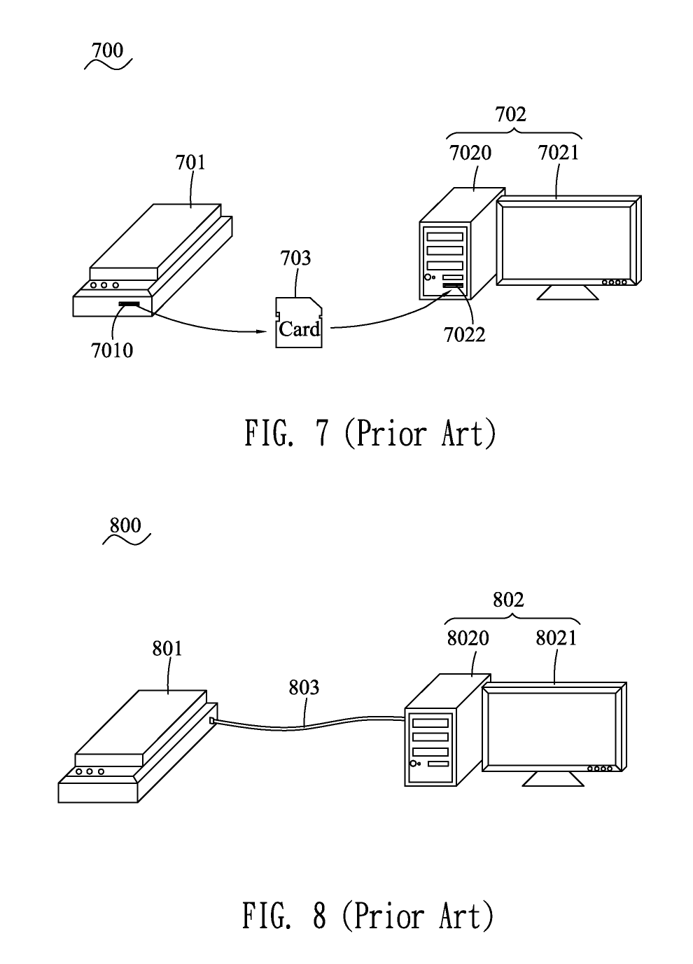

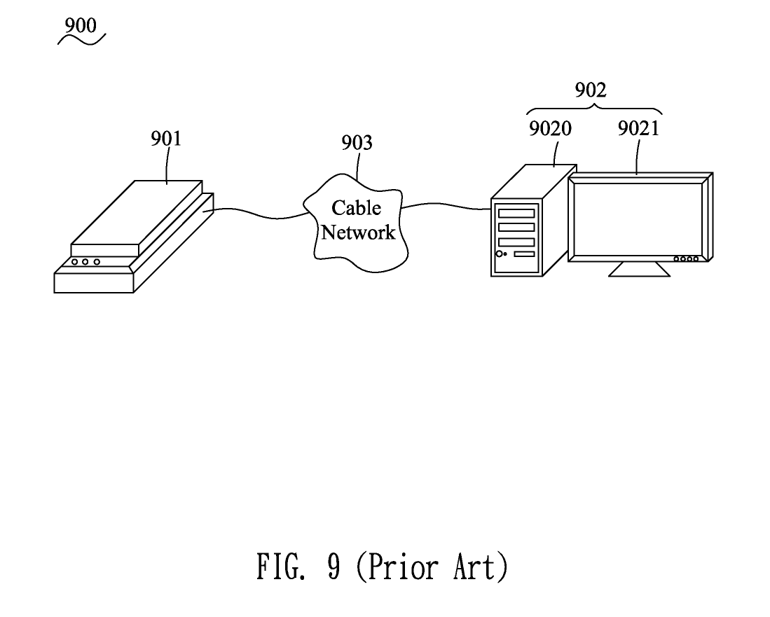

Please refer to FIG. 6, the method for real time image preview 65 includes steps as follows:

Step 650, while the e-book 5 is powered on, the second processor 51 reads the data in the second memory 52 to control the operation of the e-book 5 and start the real time image preview of the system 100. Meanwhile, the second processor 51 also controls the wireless module 53 to receive the standby information packet sent by the wireless transfer unit 13 of the handy scanner 1, and reads the data written in the code field of the standby information packet to further control the action of the e-book 5. If 0X00 is written in the code field, it represents that the handy scanner 1 maintains the standby state.

Step 651, the second processor 51 judges the scanning progress of the handy scanner 1 scanning the document according to the data in the code field. If the data of the code field is 0X40, it represents that the scanning progress of the handy scanner 1 is broken off. As a result, the program in the second memory 52 returns to execute the step 650.

Step 652, when 0X01 is written in the code field, it represents that the handy scanner 1 has began to scan the document. The second processor 51 receives an image format information packet.

Step 653, the second processor 51 further reads the data written in the data field of the format information packet to determine the format of the image. As described above, the data 0, 1, 2 and 3 represent the color high-resolution format, the color low-resolution format, the gray high-resolution format, and the gray low-resolution format respectively.

Step 654, the second processor 51 judges whether the data in the code field of the information packet is 0XFF or not. If the scan is cancelled or generates an error, the program in the second memory 52 returns to execute the step 650.

Step 658, when the data in the code field is not 0XFF, the second processor 51 records the format information of the image and further builds a memory space according to the format information of the image.

Step 659, when the code field is written in with 0X02, it represents that the information packet received by the wireless module 53 is an image information packet. Then, the second processor 51 reads the data in the length field and the data field of the image information packet to get an image data, and further stores the image data in the memory space created in the step 658 so as to drive the display module 50 to properly display the image. In detail embodiment, if the second processor 51 has not built a suitable memory space according to the format information of the image, but uses a fixed-capacity memory space to store the image data, the second processor 51 finally still can drive the display module 50 to properly display the image according to the size of the image format that can be displayed on the display module 50. For example, if the fixed-capacity memory space can store an image having a length of 20 inches and a width of 8.5 inches, but the image adapted for being displayed on the display module 50 needs meet the size of the image format with 10 inches in length and 8.5 inches in width, the second processor 51 still can read the image data stored in the fixed-capacity memory space to fit in with the image format with 10 inches in length and 8.5 inches in width, and further performs a termination code for properly displaying the image on the display module 50. In detail embodiment, the image may be compressed in a JPEG format, so the second processor 51 needs to add a termination code of FFD9 in the image so as to make the image displayed by the display module 50 in the JPEG format. Then the step 652 may be re-executed.

Step 655, when the data in the code field is 0XFF, it represents that the handy scanner 1 has completed the scanning of the document in full. Namely, the progress of the real time image transmission has been completed. Then, the second processor 51 reads the header length in the length field of the completion information packet and the header data in the data field of the completion information packet.

Step 656, the second processor 51 adds the header data in the data field of the completion information packet into the image to make the display module 50 display a full image of the document thereon.

Step 657, the second processor 51 stores the full image with a single image file, such as a JPEG file. By now, the real time image preview of the system 100 is completed. Then, the step 650 may need to be re-executed.

As described above, the system for real time image transmission and preview 100 and the method 6 thereof can be used in the wireless network, and there is the image format adapted to be displayed by the e-book 5 predetermined in the system 100. So the handy scanner 1 immediately sends the partial image to the e-book 5 after each scanning a part of the document, and the e-book 5 receives the partial image and instantaneously displays the partial image according to the predetermined image format. Thus the image can be transmitted and previewed by the system 100 in real time.

What is claimed is:

1. A system for real time image transmission and preview, comprising:
a scanner having a predetermined format therein for scanning a document based on the predetermined format, the scanner further scanning the document in lines along a direction repeatedly, the scanner capable of promptly getting an image and then wirelessly sending the image out after each linearly scanning a part of the document along the direction; and
an electrical device having a display module therein, the electrical device wirelessly receiving the predetermined format information and the image sent out by the scanner, and further editing a format of the image to fit in with the predetermined format so as to make the image capable of being displayed by the display module, wherein the display module of the electrical device promptly displays the image thereon after each linearly scanning a part of the document along the direction and the corresponding image get thereby is received by the electrical device.

2. The system for real time image transmission and preview as claimed in claim 1, wherein the scanner proceeds to scanning other parts of the document in lines along the direction after sending the image to the electrical device, the electrical device further stores all of the images in a single image file in sequence, and finally makes a complete image of the document displayed by the display module.

3. The system for real time image transmission and preview as claimed in claim 2, wherein the electrical device records the predetermined format information and further builds a memory space according to the predetermined format information for storing the image in the memory space so as to drive the display module to properly display the image.

4. The system for real time image transmission and preview as claimed in claim 3, wherein the predetermined format information includes an image compression mode and a size of the image.

5. The system for real time image transmission and preview as claimed in claim 3, wherein the image which is last stored in the memory space is read by the electrical device and then is displayed on the display module.

6. A method for real time image transmission and preview applied to a scanner and an electrical device, the electrical device including a display module, the method comprising steps as follows:
First, the scanner having a predetermined image format therein and further wirelessly sending corresponding information of the predetermined image format to the electrical device;
Second, the scanner scanning a document in lines along a direction repeatedly to promptly get a corresponding image after each linearly scanning a part of the document along the direction;
Third, the scanner promptly sending the corresponding image to the electrical device after completing each linear scanning of the document;
Fourth, the electrical device promptly receiving the corresponding image from the scanner and further editing a format of the corresponding image to fit in with the predetermined image format information which meets the demand of the display module; and
Fifth, the display module promptly displaying the edited image thereon.

7. The method for real time image transmission and preview as claimed in claim 6, wherein the scanner proceeds to scanning other parts of the document in lines along the direction after sending the image to the electrical device, the electrical device further stores all of the images in a single image file in sequence, and finally makes a complete image of the document displayed by the display module.

8. The method for real time image transmission and preview as claimed in claim 7, wherein the electrical device records the predetermined image format information and further builds a memory space according to the predetermined image format information for storing the image in the memory space so as to drive the display module to properly display the image.

9. The method for real time image transmission and preview as claimed in claim 8, wherein the predetermined image format information includes an image compression mode and a size of the image.

10. The method for real time image transmission and preview as claimed in claim 8, wherein the image which is last stored in the memory space is read by the electrical device and then is displayed on the display module.
